(19) United States
(12) Patent Application Publication
(10) Pub. No.: US 2012/0042266 A1
(43) Pub. Date: Feb. 16, 2012

(54) Method for providing a private and confidential web-based discussion forum where participants can develop ideas and solutions to various problems in a controlled and managed environment

(76) Inventor: Eleodor Sotropa, Loveland, OH (US)

(21) Appl. No.: 13/209,397

(22) Filed: Aug. 13, 2011

Related U.S. Application Data
(60) Provisional application No. 61/373,867, filed on Aug. 15, 2010.

(51) Int. Cl. G06F 3/01; G06F 15/16

(52) U.S. Cl. 715/753

(57) ABSTRACT

We present a method to provide a private and confidential web-based discussion forum where participants can develop ideas and solutions to various problems in a controlled and managed environment. The primary user of the method posts a challenge, inquiry for solutions to problems, or ideas on a website accessible only upon permission by the primary user. The primary user invites a targeted group of people, hereinafter referred as participants, of her choice to post comments, ideas, and feedback towards finding a solution to the primary user's challenge, inquiry or idea. Upon access to the website the participants post their comments, ideas, feedback to the original challenge and to the subsequent ideas, comments and suggestions. The resulting discussion and exchange of ideas and opinions between participants leads to understanding of the issues and problems associated to the challenge, creations of ideas and maturing of ideas towards finding the best solution to the original challenge. Consequently the invention provides the user with a means to tap into the collective brain power of groups of people such as organizations, customers, and institutions in a crowd-sourcing way.

### CROSS-REFERENCES TO RELATED APPLICATIONS

Under 35 U.S.C. §119(e), this application claims the benefit of priority of U.S. Provisional Patent Applications filed by inventor Eleodor Sotropa as follows: No. 61373867 filed on Aug. 15, 2010 (EFS ID 8221372, confirmation number 2619). The contents of the provisional application are incorporated by reference in their entirety.

### FIELD OF INVENTION

The present invention relates to a business method that provides users with a private and confidential web-based discussion forum where participants can develop ideas and solutions to various problems in a controlled and managed environment.

### BACKGROUND AND NEED FOR SUCH INVENTION

The development of various electronic communications means, the internet, and the worldwide web have facilitated the implementation and delivery of a wide range of personal and business services. Examples of such services are e-commerce and advertising services such as E-Bay and Amazon, electronic mail; social networking sites such as Facebook and My Space and many others. The invention in this application provides a website-based private and confidential discussion forum where participants can develop ideas and solutions to various problems in a controlled and managed environment. The party practicing the invention provides each user with a “private web-based discussion/conference room” where the user can invite a targeted group of people that he chooses. The invention allows the service provider's web application to host multiple discussion rooms for multiple users.

This invention helps organizations and groups tap into the collective brain power of their members by providing a way of communicating inquiries and questions to the targeted group of people and a way of receiving answers, feedback and solutions to the posted inquiries. These answers, comments, feedback and solutions are communicated to the targeted group of people for further analysis and comments. The dialog between participants is guided, managed and controlled towards achieving maximum efficiency. The dialog and communications among the participant members of the group will likely give rise to new ideas, solutions, and a better understanding of all the relevant factors to the posted challenge. The multiple entries of the participants will iteratively lead to improving of the ideas, to the best solutions and to an understanding of the actual issues and problems.

In the following we present a fictional situation that reveals the need for such an invention, then we present how the invention comes to satisfy this need: George is a regional manager for Starbucks Corp. Many customers and store clerks suggested that it would be nice if the stores had more armchairs (velvet, leather, and cotton) since armchairs are very comfortable and many customers like them. George knows that, unfortunately, armchairs do not last very long and they are expensive. George receives orders from stores to replace the armchairs because they are worn out and broke after only a couple of months of use. He also received numerous email complaints from customers that armchairs are worn out and ugly. Even worse, the health inspector fined the company because some of the velvet armchairs had hazardous food stains. George tried, without much success, a couple of solutions based on his own knowledge. Then he talked with a couple of store managers and store employees. Then he discussed with furniture experts, restaurant health experts, accident prevention experts, interior designers and others, many of whom were expensive outside consultants. All of these discussions yielded disparate opinions and comments which in the end did not yield any feasible solution and no much progress.

George is aware of the following shortcomings of his approach to solve this problem: (1). George does not really know what exactly happens in the stores since he did not work in a store for many years; (2). both him and the other store managers have limited knowledge about furniture, restaurant health issues; accident prevention; (3). he talked only with a few managers and employees about the armchair issue; (4). many of the people he talked with either do not care or are not very innovation minded; (5). the furniture experts and health experts he talked with did not seem to know much about how customers in stores use the armchairs and had no sense about what solutions may or may not be feasible; (6). different stores have different types of armchairs, which wear out and break differently; (7). probably the most important shortcoming of George's approach to solving the problem was that none of these many discussions assembled all the people that have the relevant expertise and knowledge to this issue. George strongly believes that there are people (i.e. employees, store managers, outside experts, customers) who can figure out the sources of the problem and find solutions to this problem if they are given the opportunity. George knows that a solution to this problem may require input from and communication between: the store managers, the furniture experts, the health experts, the accident prevention experts, the economists, the interior designers, the marketing experts and the business leaders.

The invention in this application provides people like George with a way to assemble all the people needed for solving the challenge (i.e. store managers, customers, various experts from inside the company and external) into a private web-based discussion/conference room where the participants can debate, come up with ideas, make suggestions, comment on other ideas, ask more questions towards solving George's challenge. The invention offers a means to communicate the inquiry to all the relevant people and have them all participate to the discussion of the issue such that each participant communicates to the others her idea, comments and feedback and such that each participant can see other participants' comments, opinion and ideas. The participants do not need to schedule a specific time to participate to the discussion, as in tele-conferencing, since they can check the postings on the website and enter their input whenever they have time, within the time limit set by the organizer—which can be weeks or months long.

The invention is facilitated by a web-based application whereas George can communicate the challenge to a targeted group of people of his choice via email. The targeted group of people is provided with a website where they can post their input, comments and solutions similar to the way people post comments on sites such as Facebook. Access to the website is granted only to the participants. George as the administrator of the dialog between participants can control various features of the dialog such as when the dialog is closed, he can add more participants, he can exclude participants, and he can set options. Participants can enter their input in various forms: such as text, tags, like-dislike, scores. Participants can comment with respect to one comment or place a separate posting. George would use this service the following way: he would register for the service as an administrator; he would select all the participants to the discussion; then he would invite them to discussion via email in which he provides a link to the website where the dialog will take place and other access information. The service will ensure that only people invited by George have access to the dialog. The invited parties (participants) will access the discussion website. On the discussion website the participants will see information about the party posting the challenge, description of the challenge, and other associated information such as information about participants, length of time to answer and others. Participants will be provided with an interface to enter answers, feedback and comments. A certain participant may post feedback addressed directly to the original challenge or the participant may posts feedback and comments addressed specifically to a comment or idea posted by another participant.

The discussion may go on as follows: Sally posts a comment addressed to the original challenge: “in my store I have leather armchairs and usually the first part of the armchair that wears out is the seat cushion”. Betty posts a comment addressed to Sally's comment: “The same happens to the leather armchairs in the store I manage in Alexandria, Va.”. Meredith, who is a furniture expert, comes with the comment: “the seat cushion usually wears out when the springs underneath it weaken up”. Then Mary, another store manager, comes up with the idea: “a solution would be to have armchairs with easy to replace springs”. Following Mary's comment 52 people indicate they like this idea by clicking “like” link associated to Mary's posting. George, as the challenge administrator, directs a number of participants (the furniture experts, the marketing experts, the engineer, and the health expert) to analyze Mary's idea and post a conclusion report within 2 weeks. Two weeks later the group assigned to perform the research posts their report: “while the idea is good, there are some shortcomings to this solution in the sense that it is not easy to replace the springs. Our furniture expert is working right now to find an easier way to replace the springs and will let us know in five days”. The discussion goes on like this until the administrator decides that it attained its purpose or that further discussion is unlikely to yield new ideas and useful comments. In order to reward participants for their contributions and coming up with useful ideas and comments, George rates the participants by awarding them “innovation points” and “activity points” commensurate with their contributions and awards prizes to the most innovative of them. This way people have an incentive to participate to such discussions and come up with innovative ideas. After that, George thanks all participants, announces the awards, and declares the discussion closed.

The invention in this application combines the flexibility of webs-based discussion with the rigor of managed and controlled corporate meetings and conferences.

The invention provides organizations with an efficient and cost effective way to tap into the collective brain power of groups of people.

### SUMMARY OF INVENTION

In the following we present the method and the system supporting the invention:

(1). Hosting a website and providing an on-line service.

The invention is implemented via a website and an on-line service where users can open accounts; access these accounts; create profiles; post various forms of entry (such as text, files, pictures, video and others) on the said website; view the entries they and other participants posted; associate their entries to other entries posted on the website; send messages to others. The said website has all the functionalities of an e-commerce website. The website hosts the discussion forum.

(2). Starting a discussion session by opening an account as administrator, creating a profile and posting various items on the discussion website.

The primary user (hereinafter “the challenge administrator” or “the administrator”) starts a discussion session by opening an account on the host web-based system, as “challenge administrator” which grants him access to use the functionality of the web-based system supporting the discussion forum invention. The administrator creates his profile on the website in a way similar to the way users of social networking services such as Facebook and LinkedIn create a profile to use these services. The administrator is enabled to post text and other various types of files and elements on the said web site.

The administrator is provided with a template internet form that enables him to enter text describing facts and items such as: the main challenge or inquiry to find a solution to a problem; sponsor's email; information associated to the challenge; other questions associated to the main challenge; meta-tags describing the area of expertise that idea pertains to; information about management of the discussion such as the number of days the challenge is kept active and others. The form also provides the administrator with a way to upload files on the website relevant to the inquiry and make these files available to be seen and download by the discussion participants.

The administrator is enabled to set the access information to the discussion forum information, such as usernames and passwords that the invited parties can use to access the discussion room. The administrator is enabled to post the information entered in the template form (or only part of it) on the discussion room website similar to the way a user posts a message on Facebook.

(3). Inviting parties to the discussion forum—the discussion participants.

The “challenge administrator” communicates to parties of his choice one or more of the following: an inquiry for solutions, ideas, comments or feedback; an idea; a message. The administrator may use various ways to communicate the said inquiries, ideas and messages to the parties of his choice such as: by email, posted on a website; text message and others. The administrator is enabled to create a list with the emails of the targeted parties he wants invited to the discussion. The primary user (i.e. the administrator) is enabled to communicate the invited parties the information needed to access the discussion website.

(4). Registration as discussion participant and creating a participant profile

The invited parties access the website hosting the discussion, also referred as the “discussion room”. This can be done via a web-link, username and password login, or other ways. The invited parties (hereinafter “the discussion participants” or “the participants”) are provided with a means to create their profile. Such means includes, but is not limited to, an on-line form that creates their profile (similar to the way users of social networking services such as Facebook and LinkedIn create a profile to use these services). Participants' profile may contain identifying information and other information that the administrator wants the participants to know about each other such as: name, expertise, association, rank, innovation score, picture etc. The interest and expertise of a participant may be described by using descriptive meta-tags such as “sales”, “database”, “health issues”.

The participants post/publish their profiles on the website such that other participants can see it. The participants are enabled to see on the discussion website the published information about the administrator, the challenge, the associated information, and the list of participants. The participants are enabled to see on the website hosting the discussion the information posted by other participants (similar to the way an account owner on Facebook sees his friends' posted comments and entries).

(5). The participants and the primary user can post on the discussion forum feedback, ideas, answers and comments.

The participant is enabled to post his feedback, answers, ideas and comments to the challenge or inquiry posted by the administrator. The participant can do that in ways such as: the participant clicks a web-link identifying the action performed by suggestive words such as “post a comment” and “post an idea”; upon clicking the web-link a window template activates where the participant writes his comments and answers to the challenge. The participant is enabled to associate with their idea meta-tags describing the area of expertise that idea pertains to (e.g. marketing, food-safety, and transportation). The participant publishes the said posted idea, comments and feedback on the website such that other participants see the said ideas, comments and feedback (similar to the way a user posts a message on Facebook).

The participant associates the comments, answers and feedback he posts to the main challenge posted by administrator. The participant associates the comments, answers and feedback he posts to specific entries posted by a other participants (similar to the way a participant on Facebook posts a comment associated to an item such as text, picture, video).

Such means of posting feedback to various items on the discussion board (i.e. ideas, comments) include, but are not limited to, the following: textual—whereas the participant posts a text message or comment; point rating—whereas ideas are rated by a number from 1 to 5 where 1 is for very good and 5 is for bad; “like” and “dislike” tags; meta-tags describing the area of expertise that idea pertains to; and “subscribe to idea”. The feedback is posted under categories describing the type of entry such as: “idea”; “comment”; “note”; “expert opinion”; “suggestion”; and “to do task”.

The system notifies the participant that authored a certain entry (i.e. idea, comment, suggestion, to do task) when another participant posted a comment associated with his posting. Such a means includes, but is not limited to, email notification.

The website interface presents the administrator and the participants with information that may include, but is not limited to, the following: information about discussion; statistics concerning ideas; statistics concerning users; related ideas; idea participants; idea tags; information about the other participants (i.e. participants' profile); information about the sponsor organization; information about the challenge and associated issues; participants that subscribe to an idea; and any other information that might be useful.

(6). Supporting discussion development and discussion branching in sub-discussions on sub-issues.

Discussions between many parties and on complex issues often evolves in discussions on specific issues (sub-issues to the main challenge). Usually only a sub-group of participants have interest and expertise in the specific sub-issue or topic. Consequently the discussion stream splits into sub-discussions on specific topics and only a specific sub-groups participates to such sub-discussion. Very likely the various sub-problems and sub-issues which will naturally stem out of the original challenge will be discussed separately by the participants with expertise and interest in these sub-problems. Naturally, entries will be posted associated (linked) to other entries and evolve on branches of entries. To address the natural branching of discussions in sub-issues the invention uses a graphical interface to follow such branching of the discussion entries into sub-issues.

(7). Launching sub-challenges and organizing sub-discussions.

The participants create and launch sub-challenges in order to obtain feedback and find solutions to sub-issues of the main challenge. The participants communicate to other participants a request to participate in a certain sub-discussion on a sub-issue.

(8). Managing and directing the discussion.

The administrator manages and directs the discussion. Such means may include, but are not limited to, the following: the administrator directs participants to pay attention to a specific entry exchange; the administrator designates the forms of feedback that participants can enter (i.e. text, scores, ratings, like-dislike); the administrator directs a participant to perform an action; the administrator adds or excludes participants; administrator sends status reports to participants; the administrator manages the discussions on sub-topics and prompts participants on discussions in sub-groups to reach a conclusion and publish that conclusion in the main stream; the administrator screens the discussion on a specific sub-topic from some participants and keeps it only in a sub-group he chooses. The administrator can form separate discussion rooms and publishes in the main discussion room only the conclusion of a discussion in the separate discussion room.

The administrator delegates various powers and assigns tasks to other participants. Such delegated powers may include, but are not limited to, the following: the administrator may designate some of the participants to manage a discussion on a specific topic in a separate room; the administrator may designate a certain participant to write a conclusion or a report on a certain subject; the administrator may assign a participant to perform research on a certain subject area, write a report and post the report on the website; the administrator may designate some of the participants as “experts” and delegate them the power to rate the posted entries and rank the ideas by certain ranking criteria set and selected by the administrator. Examples of such ranking criteria are: rank by ease of implementation; rank by value towards the challenge; rank by the resources needed; and rank by the strategic fit.

The discussion facilitated by the invention will lead to collaboration and exchange of opinions, solutions, ideas, explanations, and analysis between participants with various expertises and background. In turn this will bring better understanding of the problems associated with the challenge and will lead to growing and maturing of ideas and solutions towards the best solution to the challenge.

(9). Rating the participants.

The participants are provided with controls whereas they can for rate each discussion participant for being active in the discussion room, for posting valuable comments, and for posting innovative ideas and solutions. Such means include, but are not limited to, the following: awarding activity points; awarding innovation points; awarding contribution points; awarding stars (similar to rating of videos posted on YouTube service).

(10). Keeping track of the ratings earned by participants from one discussion session to another and enabling participants to accumulate points of such ratings.

The invented system provides controls for keeping track of the ratings (i.e. points) earned by participants from one discussion session to another and enables participants to accumulate points. The points are portable from one discussion session to another and over time. The activity points a person earns over time are proof and a measure of his diligence and active spirit. The innovation points a person earns over time are proof and a measure of his innovative abilities. The purpose of keeping records of the “activity points” and “innovation points” earned by a person is to reward the innovative and active participants. Another purpose of keeping records of a person's “activity points” and “innovation points” is to have a measure of that person's competence and innovation in his future participation to discussions and debate. The innovation points and activity points are a relevant item on that person's Resume.

The party practicing the invention can practice it in various circumstance and various ways. For instance, the party practicing the invention may practice it as a service provided to other parties on a contractual basis in consideration for a fee; or the party practicing the invention may be a corporation, group, organization, institution and practice the invention for its own benefit.

Various levels of flexibility, sophistication, functionality and complexity can be implemented and built over the invention if necessary. For instance, the service may provide participants with the option to send messages only to a specific participant; the service may provide chat rooms and tele-conferencing rooms for the entire group or for sub-groups; the service may provide the administrator with the option to form separate discussion rooms where the issues discusses there are kept confidential within the sub-group.

Various data files and items can be posted on the website interface and made available to the participants such as: pictures, video files, sound files, hyper-links, file-download links and others. Various information items can be posted on the website interface and made available to the participants such as: information about discussion; statistics about ideas; related ideas; idea participants; idea tags; information about the other participants (i.e. participants' profile); information about the sponsor organization; information about the challenge and associated issues, and any other information that might be useful.

A user can see multiple challenges and participate to all the discussions he is invited to. The party practicing the invention can host multiple discussion rooms for multiple parties. The party practicing the invention provides each user with a “private website discussion/conference room” where the user can invite a targeted group of people that he chooses. The invention allows the service provider's web application to host multiple discussion rooms for multiple users. The users are provided with the option of keeping the discussions private and confidential such that only the participants to the discussion have access to the information posted in on the web discussion room, not even the service provider. The party practicing the invention can provide multiple discussion rooms for multiple users and the users and participants in one room do not know about the users and participants in another room. Various levels of confidentiality and security can be provided such as encryption and secure connection as needed or as the customer desires.

### DESCRIPTION OF THE BEST MODE

The party practicing the invention provides each user with a “private web-based discussion/conference room” where the user can invite a targeted group of people that he chooses. The invention allows the service provider's web application to host multiple discussion rooms for multiple users. In the following we specify the best mode and preferred embodiment:

(1). Providing a web-based discussion room. Opening an account and posting a challenge in the discussion room (on the discussion board).

The party practicing the invention hosts a website and provides an on-line service where users can open accounts; access these accounts; create profiles; post various forms of entry (such as text, files, pictures, video and others) on the said website; view the entries they and other participants posted; associate their entries to other entries posted on the website; send messages to others. The said website has all the functionalities of an e-commerce website.

The party practicing the invention provides a service to users via a website and web based application whereas the primary user opens an account on the service website as a “challenge administrator” (hereinafter the administrator). The web application provides the administrator with a multi-field internet form where he enters text describing the following: the main challenge or inquiry to find a solution to a problem; sponsor's name; sponsor's associations with a relevant organization; sponsor's email; information associated to the challenge; other questions associated to the main challenge; meta-tags describing the area of expertise that idea pertains to such as “sales”, “database”, “health issues”; information about management of the discussion such as the number of days the challenge is kept active and others. The form also provides the administrator with a control for uploading files on the website (e.g. via a browse field and upload button) relevant to the inquiry and make these file available to be seen and download by the discussion participants. The web-form provides the administrator with controls for setting the usernames and passwords that the invited parties can use to access to the discussion room. When the administrator completes filling out the form he clicks a “publish” button which posts the challenge and associated information, as entered into the web-form, on the discussion room web site similar to the way a user posts a message on Facebook.

(2). Inviting parties to the discussion forum—the discussion participants.

The web-form also provides the user with controls that allows them to create a list with the emails of the targeted parties he wants invited to the discussion. The user is provided with a means to send emails to all addresses in the list. The user is provided with a means to send an email containing the description of the challenge and associated information as published on the website. The email sent to the invited parties also contains a web-link of the discussion website and other website access information such as login, password, and other identifiers (i.e. discussion room identifier).

(3). Registration as discussion participant and creation of a participant profile.

The invited parties will access the website hosting the discussion (also referred as the discussion room) via a web-link and login information (e.g. username and password). After they successfully login the invited parties (hereinafter “the discussion participants” or “the participants”) are prompted to fill an on-line form that creates their profile. Participants' profile contains identifying information and other information that the administrator wants the participants to know about each other (e.g. name, expertise, association, rank, innovation score, picture etc.). The interest and expertise of a participant is described by using descriptive meta-tags such as “sales”, “database”, “health issues”. Upon completion, the participant's profile is published on the website such that other participants can see it. Upon completion of the login process, the participants can see the published information about the administrator, the challenge, the associated information, and the list of participants. The participants will see on the website hosting the discussion the information posted by other participants (similar to the way a user an account owner on Facebook sees his friends' posted comments and entries).

(4). Posting feedback, ideas, answers and comments.

The participant is provided with controls for posting his feedback, answers, ideas and comments to the challenge or inquiry posted by the administrator by clicking a web-link identifying the action performed (e.g. “post a comment”, “post an idea”). Upon clicking the web-link a window template pops up (or activates) where the participant writes his comments and answers to the challenge. Participants that post an idea (also known as innovators) associate with their idea meta-tags describing the area of expertise that idea pertains to. When the participant completes his entry he clicks a publish button which publishes the text on the website. Once the text is published all the other participants can see it posted on the discussion room together with the identity of the participant that posted the text. Similar to the way a user posts a message on Facebook.

The participant can post comments, answers, and feedback to the main challenge posted by administrator. Also the participant can post comments, answers and feedback directed to a specific entry posted by a certain participant. The comments, answers, and feedback will be posted on the web-interface associated with the specific entry to which the comments are directed.

The participants are provided with controls for posting feedback to various items on the discussion board (i.e. ideas, comments) in various forms such as: textual—whereas the participant posts a text message or comment; point rating—whereas ideas are rated by a number from 1 to 5 where 1 is for very good and 5 is for bad; “like” and “dislike” tags; meta-tags describing the area of expertise that idea pertains to. The feedback is posted under categories describing the type of entry such as: “idea”; “comment”; “note”; “expert opinion”; “suggestion” and “to do task”. The innovator that authored a certain entry (e.g. idea, comment, suggestion, to do task) is notified by email whenever an entry associated to his idea has been posted.

(5). Information posted on the website interface.

The website interface presents the administrator and the participants with various information, such as: information about discussion; statistics concerning ideas; statistics concerning users; related ideas; idea participants; idea tags; information about the other participants (e.g. participants' profile); information about the sponsor organization; information about the challenge and associated issues; participants that subscribe to an idea; and any other information that might be useful.

(6). Supporting discussion development and discussion branching in sub-discussions on sub-issues.

Discussions between many parties and on complex issues often evolves in discussions on specific issues (sub-issues to the main challenge). Usually only a sub-group of participants have interest and expertise in the specific sub-issue or topic. Consequently the discussion stream splits into sub-discussions on specific topics and only a specific sub-groups participates to such sub-discussion. Very likely the various sub-problems and sub-issues which will naturally stem out of the original challenge will be analyzed and discussed separately by the participants with expertise and interest in these sub-problems. The conclusion reached in such sub-discussion on sub-issues is fed back (published) in the main stream of entries.

(7). Creating teams across ideas by “subscribing to ideas.”

Participants may create and launch sub-challenges in order to obtain feedback and find solutions to sub-issues of the main challenge. The participant that launches a sub-challenge can launch it in the primary discussion room (posed to the entire group of people) or the participant can launch the challenge into a separate room to a group of people of his choice. The conclusion reached in such sub-discussion on sub-issues is fed back (published) in the main stream of entries in the primary discussion room.

Participants are provided with a way to show their support to an “idea” and/or to show their desire to participate in debating that idea by “subscribing” to that idea. The participant accomplishes that by clicking the “subscribe” link associated with that idea. Upon subscribing to an “idea” the participant name is added to the list of participants subscribing to that idea. The list is published on the website window associated with that idea. This way participants that subscribe to a certain idea are assembled in a team with relevant expertise to develop that idea. Recruiting of more participants whose expertise is relevant to a certain idea is done by matching the meta-tags associated with that idea with the meta-tags describing participants' are of interest.

(8). Managing and directing the discussion.

The administrator can delegate various powers and assign tasks to other participants. For instance, the administrator may designate some of the participants to manage a discussion on a specific topic in a separate room, or the administrator may designate a certain participant to write a conclusion a report on a certain subject, or the administrator may assign a participant to perform research on a certain subject area, write a report, and post the report on the website. The administrator may designate some of the participants as “experts” and delegate them the power to rate the posted entries and rank the ideas by certain ranking criteria set and selected by the administrator. Examples of such ranking criteria are: rank by ease of implementation; rank by value towards the challenge; rank by the resources needed; and rank by the strategic fit.

The administrator is provided with controls for managing the discussion such as: the administrator can direct all participants to pay attention to a specific exchange; the administrator designates the forms of feedback that participants can enter (i.e. text, scores, ratings, like-dislike); the administrator can direct a participant to perform an action; the administrator can add or exclude participants; administrator can send status reports to participants; the administrator can manage the discussions on sub-topics and prompt participants on discussions in sub-groups to reach a conclusion and publish that conclusion in the main stream. The administrator may want to screen the discussion on a specific sub-topic from some participants and keep it only in a sub-group. The service provides the administrator with the option to form separate discussion rooms and publish in the main discussion room only the conclusion of a discussion in the separate discussion room.

The discussion will lead to collaboration and exchange of opinions, solutions, ideas, explanations, and analysis between participants with various expertise and background. In turn this will bring better understanding of the problems associated with the challenge and will lead to growing and maturing of ideas and solutions towards the best way to find a solution to the challenge.

(9). Rating participants by “activity points” and “innovation points”

The service provides controls for rating and scoring each discussion participant for being active in the discussion room (activity means posting ideas, comments, suggestions) by awarding them “activity points” for each posting. The service provides a means to rate and score each participant for creating valuable ideas and posting valuable comments by awarding them “innovation points”. The administrator (or parties assigned by him to perform such rating, or an automatic system) will associate points with participant's profile.

The service provides controls for keeping track of the “activity points” and “innovation points” the participant earned in one discussion/challenge session. The points are portable from one discussion session to another and over time (even if the sponsor does no longer have any active challenge). The activity points a person earns over time are proof and a measure of his diligence and active spirit. The innovation points a person earns over time are proof and a measure of his innovative abilities. The purpose of keeping records of the “activity points” and “innovation points” earned by a person is to reward the innovative and active participants. Another purpose of keeping records of a person's “activity points” and “innovation points” is to have a measure of that person's competence and innovation in his future participation to discussions and debate. The innovation points and activity points are a relevant item on that person's Resume.

Although the present invention has been described with respect to the preferred embodiment, numerous modifications and variations can be made and still the result will come within the scope of the invention. No limitation with respect to the specific embodiment disclosed herein is intended or should be inferred.

What is claimed is:

1. A method for providing a private and confidential web-based discussion-forum where people participate to discussions and develop ideas and solutions to problems in a controlled and managed environment, the method comprising:
(a) a service-manager hosts a website-interface supporting said discussion-forum, wherein users open accounts, access said accounts, create profiles, post entries which are displayed on the website-interface, view entries posted by said users, associate entries to other entries posted on the discussion forum, and send messages to other users;
(b) a party that wants to find a solution to a problem, wherein said party is hereinafter referred as challenge-administrator, starts a discussion session by opening an account on the discussion-forum, creating his profile, posting a description of said problems, hereinafter called discussion-challenge, and posting entries associated with said discussion-challenge;
(c) the challenge-administrator invites parties of his choice to participate to the discussion as discussion-participants;
(d) the invited parties register as discussion-participants in the discussion-forum and create participant-profiles;
(e) the discussion participants post entries containing feedback, ideas, answers, and comments to the challenges posted by the challenge-administrator and to the entries posted by other participants;
(f) the entries are sequentially posted on the website-interface supporting the discussion-forum and develop in streams of entries;
(g) the challenge-administrator uses controls on the website-interface to set permissions for each participant with respect to viewing entries posted in the discussion forum;
(h) the challenge-administrator uses controls on the website-interface to set permissions for each participant with respect to posting entries in the discussion forum;
(i) the discussion participants can view on the website-interface the entries posted by the other participants and by the challenge-administrator;
(j) the challenge-administrator or its assignees are managing and directing the discussion;
(k) the challenge-administrator ends the discussion session and removes participants' access to the discussion session when said challenge-administrator considers that the purpose of the discussion forum has been achieved or whenever he sees fit;
and wherein
(l) the only parties that have access to view the entries posted in the discussion-forum are the parties that are invited by the challenge-administrator or parties that have permission from the challenge-administrator to view the said certain entry;
(m) the only parties that have access to post entries in the discussion-forum are the parties that are invited by the challenge-administrator or parties that have permission from the challenge-administrator to post entries in the discussion forum;
(n) a participant has access to see a certain entry in the discussion room only if he has permission from the challenge administrator;
(o) a participant has access to post entries in a certain place on the stream of entries in the discussion-forum only if he has permission from the challenge-administrator;
(p) the challenge administrator can modify the permissions of any party and any participant;
(q) a party can become challenge-administrator and launch a discussion-challenge only upon obtaining permission from the service-manager;
(r) the service-administrator can remove challenge-administrator's access to the discussion-forum and the service-administrator can terminate participants' access to the discussion-forum; and
(s) the participants provide in their profiles information regarding their qualifications relevant to the discussed problems and the information indicated by the challenge-administrator.

2. The method of claim 1, wherein the service-administrator allows the challenge-administrator to use the discussion-forum upon a contractual agreement.

3. The method of claim 1, wherein the discussion-participants or parties assigned by the challenge-administrator are rating the entries posted by other participants according to parameters such as: the value brought by said entries to solving the posted problems; and the innovative value of said entries.

4. The method of claim 1, wherein the participants to a discussion session are rated by the challenge administrator and by parties assigned by the challenge administrator according to participant's performance in said discussion session participant's activity, participants' contribution to solving the problem, and participant's innovative spirit.

5. The method of claim 1, wherein the profiles of the participants are kept for use in subsequent discussion sessions.

6. The method of claim 5, wherein participants are assigned ratings and scores which are calculated function of parameters such as participants' ratings in individual discussion sessions and wherein said ratings and scores are included in participant's profile.
